(19) United States
(12) Patent Application Publication
(10) Pub. No.: US 2025/0076746 A1
(43) Pub. Date: Mar. 6, 2025

(54) LOW-COST DIGITAL VIDEO PROJECTOR

(71) Applicant: MINDSCOPE PRODUCTS, Glendale, CA (US)

(72) Inventors: GEORGE BALANCHI, ALTADENA, CA (US); JOHN SINISI, WARMINSTER, PA (US)

(21) Appl. No.: 18/210,620

(22) Filed: Jun. 15, 2023

Related U.S. Application Data
(60) Provisional application No. 63/406,565, filed on Sep. 14, 2022.

(51) Int. Cl. G03B 21/16; G03B 21/00; G03B 21/20

(52) U.S. Cl. CPC G03B 21/16; G03B 21/006; G03B 21/2033; G03B 21/2066; G03B 21/208

(57) ABSTRACT

The present invention is generally directed to a low-cost projector. In general, a projector for use in a household item, decoration, or toy, the projector may include: at least two housing shells, which mate together to form a projector housing, the at least two housing shells comprising a reflector cone portion molded into the at least two housing shells; a printed circuit board, including a processor, memory store, and video driver; a liquid crystal display (LCD) for displaying an image, animation, and/or video; a light emitting diode (LED), configured to emit light though the LCD, thereby projecting the image, animation, and/or video on the LCD; one or more Fresnel lenses, disposed between the LED and the exterior of the projector; one or more lenses, disposed between the LCD and the exterior of the projector.

### RELATED APPLICATIONS

This application claims priority to U.S. Provisional Patent Application No. 63/406,565, filed on 14 Sep. 2022, entitled “Low-Cost Digital Video Projector,” which is incorporated herein by reference in its entirety.

### BACKGROUND

Various household items, decorations, and/or toys may incorporate the use of a projector to project various images, animations, and/or video data. Such projectors may project outside of an item—such as on a wall or exterior surface, or may project on a surface or portion of the household item, decoration, and/or toy itself.

Digital projectors as known in the art are generally focused on obtaining the largest size projection with the best image possible, at an acceptable cost. In order to achieve this, many prior art projectors include a number of components, including but not limited to lenses, filters, diffusers, and/or reflectors to direct the light and image in a specific way to provide minimal distortion. Typically, each component is a separate part of an overall assembly, which must be separately manufactured and subsequently assembled.

Prior art projectors generally require light path management due at least in part to the sensitivity of the liquid crystal display (LCD) and the optical clarity required or desired for a clear projection.

Therefore, it is a goal of the present invention to provide a low-cost, easy to manufacture projector which comprises integrally formed components, thereby reducing manufacturing and assembly costs.

### SUMMARY OF THE INVENTION

In accordance with some aspects of the present invention, aspects may include a projector for use in a household item, decoration, or toy, the projector comprising at least two housing shells, which mate together to form a projector housing, the at least two housing shells comprising a reflector cone portion molded into the at least two housing shells; a printed circuit board, comprising a memory store, processor, and video driver; a liquid crystal display (LCD) for displaying an image, animation, and/or video; a light emitting diode (LED), configured to emit light though the LCD, thereby projecting the image, animation, and/or video on the LCD; one or more Fresnel lenses, disposed between the LED and the exterior of the projector; and one or more lenses, disposed between the LCD and the exterior of the projector.

In accordance with some aspects of the present invention, aspects may include a projector for use in a household item, decoration, or toy, the projector comprising: at least two housing shells, which mate together to form a projector housing, the at least two housing shells comprising a reflector cone portion molded into the at least two housing shells, the reflector cone portion polished to provide a reflective surface, the at least two housing shells molded to provide one or more mounts for various components; a printed circuit board, comprising a memory store, processor, and/or video driver; a liquid crystal display (LCD) for displaying an image, animation, and/or video; a light emitting diode (LED), configured to emit light though the LCD, thereby projecting the image, animation, and/or video on the LCD; a diffuser, disposed at least in part around the LED; one or more Fresnel lenses, disposed between the LED and the exterior of the projector; one or more lenses, disposed between the LCD and the exterior of the projector; and a heat sink, thermodynamically connected to the LED and configured to dissipate heat generated by the LED.

These and other aspects will become apparent from the following description of the invention taken in conjunction with the following drawings, although variations and modifications may be affected without departing from the scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary low-cost projector, in accordance with some embodiments of the present invention.

FIG. 2 illustrates an exemplary low-cost projector, in accordance with some embodiments of the present invention.

FIG. 3 depicts an exemplary low-cost projector, in accordance with some embodiments of the present invention.

FIG. 4 depicts an exemplary low-cost projector, in accordance with some embodiments of the present invention.

FIG. 5 illustrates a perspective view of a low-cost projector, in accordance with some embodiments of the present invention.

FIG. 6 illustrates exemplary electronic components that may be used in a low-cost projector, in accordance with some embodiments of the present invention.

### DETAILED DISCUSSION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, the present invention is directed to a low-cost video projector for use in household items, decorations, and/or toys. More specifically, the present invention is directed to a projector that is integrally formed with various components.

As briefly noted above, most prior art projectors utilize separate components that are separately manufactured and subsequently assembled. For example, many prior art projectors may comprise separate internal reflector cups, one or more polarizers, cooling fans, etc. In accordance with some embodiments of the present invention, one or more of such components may be integrally formed into a projector housing, thereby reducing manufacturing costs and/or assembly costs.

For example, in accordance with some embodiments of the present invention, the need for a separate reflector may be eliminated by incorporating a cone shape into a molded projector external housing. In addition, polishing the internal surface of the exterior housing may be polished into a mirror surface, thereby obviating the need for reflective paint or a reflective coating. Accordingly, the mirror surface and internal shape of the external shell may operate as a reflective cone, without a need for a separate component. For example, the surface may be treated with chemicals, paint, anodizing, and/or plating to increase reflectivity.

Additionally, existing prior art projectors generally comprise one or more polarizers, configured to eliminate glare from a liquid crystal display (LCD), as well as enhance overall color of the LCD. In general, polarizers may be manufactured from special—and costly—glass and increase the cost of a projector. In accordance with some embodiments of the present invention, a polarizer may be omitted. In some embodiments, at least some functionality of the polarizer may be at least in part replicated by changing the image contrast. In addition, an optional molded LED refractor may be added to eliminate hot spots in a projection.

In order to provide a large overall image with a short throw, one or more series of Fresnel lens diffusers and image adjusters may be used to reduce the overall projector size while using a relatively large LCD. This may result in less plastic material and reduce manufacturing costs and assembly costs.

In addition, to make assembly more efficient and cost effective, at least some lens holders and/or mounts for LEDs or LCDs may be integrally formed into only two portions-comprising a top and bottom body shell. Such body shells may be snapped or screwed together with less additional part to assembly. In accordance with some embodiments, projector body shells may be manufactured in one piece with a living hinge.

As noted above, most LED projectors use a cooling fan, which may push or pull cool air across a heat sink, in order to keep the LED cool so that it does not damage a LCD. In accordance with some embodiments of the present invention, the heat sink may be enlarged, and mounted such that fins are configured vertically. Vertically configured fins may allow natural airflow therethrough, as warmer air rises between the fins. Vertical fins may create chimney effect, that may pull cool air from the bottom and push it out the top. Heat dissipation may be further improved by configuring the heat sink fins external to the projector housing, so that less heat is trapped within the housing itself. Elimination of a fan may further reduce the size of a projector, as well as its cost, assembly complications, and/or power consumption requirements. In accordance with some embodiments of the present invention, heat sink may be made from any appropriate material, such as but not limited to aluminum.

While each of these changes may appear somewhat inconsequential alone, when taken together the resulting product may be a projector with fewer components that requires less manufacturing and assembly, and has a lower cost to produce.

Projectors in accordance with some embodiments of the present invention may also include additional optional elements, such as a speaker, audio driver, aluminum portions to act as a reflective cone, LCD driver board, button board, power board, and/or polarizing filter. Note that while there are numerous advantages to omitting a fan, in some embodiments it may be appropriate to add a fan to ensure proper cooling of the projector. The addition of an optional fan does not detract from the other advantages of the present invention.

A projector may also include an electronic LCD driver board, which may—for example—have a flash memory that hold both video and audio data, as well as drivers for displaying and/or playing the same. In accordance with some embodiments of the present invention, an electronics LCD driver board may be configured to hold seventy (70) minutes of audio and video.

An optional electronics button board may also be included in a projector in accordance with the present invention. Such a button board may include buttons for user interaction, including—for example—one or more volume buttons and/or a button to skip the current projection and go to the next. Additional buttons may be included—such as but not limited pause, play, forward, backward, skip, input selection, power button, etc. In some embodiments, a power switch or button may be separately located on a power board.

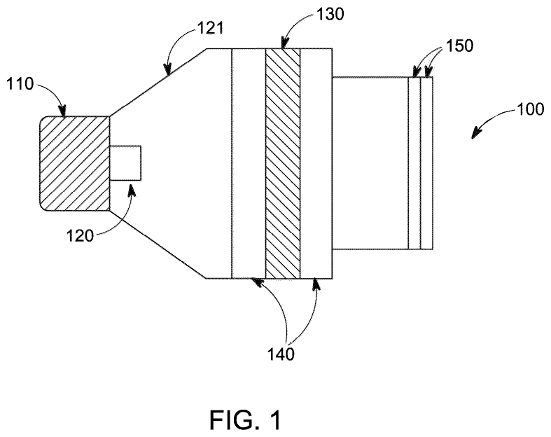

Now that the invention has been generally described, attention is now drawn to the figures. FIG. 1 illustrates an exemplary projector in accordance with some embodiments of the present invention. In general, projector 100 may comprise a heat sink 110, light emitting diode (LED) 120, LCD 130, one or more Fresnel lenses 140, and/or one or more lenses 150. Housing for the projector 100 may comprise a light reflector incorporated into the external body shell as one part. The heat sink 110 may extend exterior to the housing and may be used to induce a chimney effect to passively assist with cooling without requiring a fan. The projector may also omit a polarizer, instead utilizing the one or more Fresnel lenses 140 and additional lenses 150 to provide sufficient image quality.

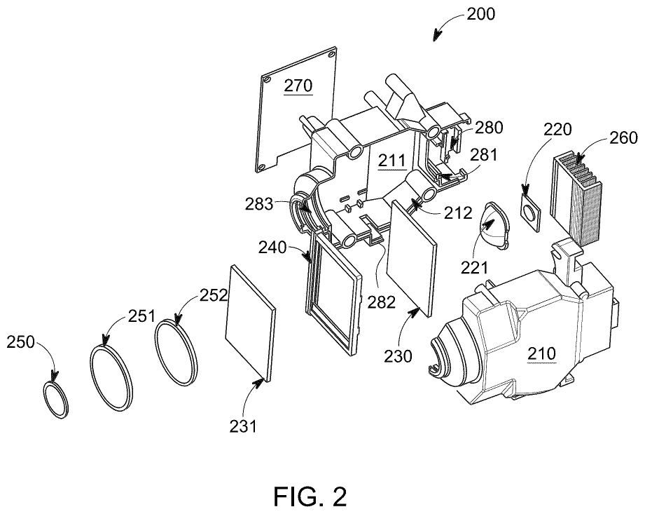

FIG. 2 illustrates an exemplary low cost projector 200, in accordance with some embodiments of the present invention. The projector 200 may comprise two housing shells 210, 211, which may include a reflector cone 212 molded into the exterior shell shape.

The projector 200 may further comprise an LED 220, and may optionally include an LED lens/diffuser 221. A first Fresnel lens 230 may be disposed between the LED 220 and an LCD 240. A second Fresnel lens 231 may be disposed on an opposite side of LCD 240. One or more lenses 250, 251, 252 may be sequentially arranged, as needed, between the second Fresnel lens and the exterior of the projector. Heat sink 260 may be disposed on the rear surface of the projector 200, with fins configured vertically, and extending at least in part beyond the housing shells 210, 211. Printed circuit board 270 may be attached to the projector shell. Printed circuit board 70 may comprise one or more processors, memory stores, etc., which may be used to store one or more animations and play the animations to the LCD 240.

In accordance with some embodiments of the present invention, the housing shells 210, 211 may comprise a variety of molded mounts for the various components of the projector. For example, mount 280 may be configured to receive LED 220. Mount 281 may be configured to receive an LED lens/diffuser 221. Mount 282 may be configured to receive the LCD 240, the first Fresnel lens 230, and/or the second Fresnel lens 231. Mount 283 may be configured to hold one or more of lenses 250, 251, 252.

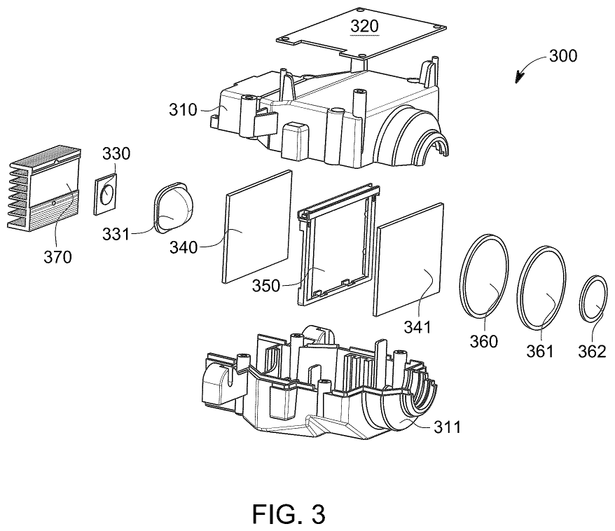

With reference to FIG. 3, a second embodiment of a low cost projector 300 will now be discussed. The projector 300 may comprise a top shell/reflector 310 and a bottom shell/reflector 3100. A printed circuit board (PCB) 320 may be attached to the top shell/reflector 310. As in the previous embodiment, the projector 300 may further comprise an LED 330, optional diffuser 331, one or more Fresnel lenses 340, 341, an LCD 350, one or more lenses 360, 361, 362, and/or a heat sink 370.

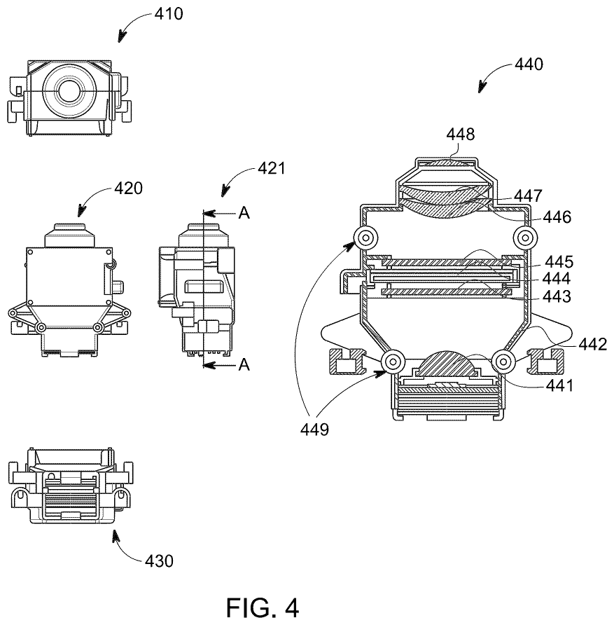

FIG. 4 illustrates various section views of a low-cost projector, in accordance with some embodiments of the present invention. View 410 illustrates a straight-on view directly into the lenses of the projector. View 420 shows a top view a projector, while view 430 illustrates a back view of the projector. View 421 illustrates a side view, with section view A-A. FIG. 440 represents section view A-A, which may include an LED lens 441 which may include an LED lens/diffuser, a cone shape molded into the body 442, a first Fresnel lens 445, a second Fresnel lens 443, an LCD 444, and/or one or more lenses 446, 447, 448. View 440 also illustrates one or more attachment portions 449, through which one or more fasteners—such as screws—may be used to attach the two shells to each other.

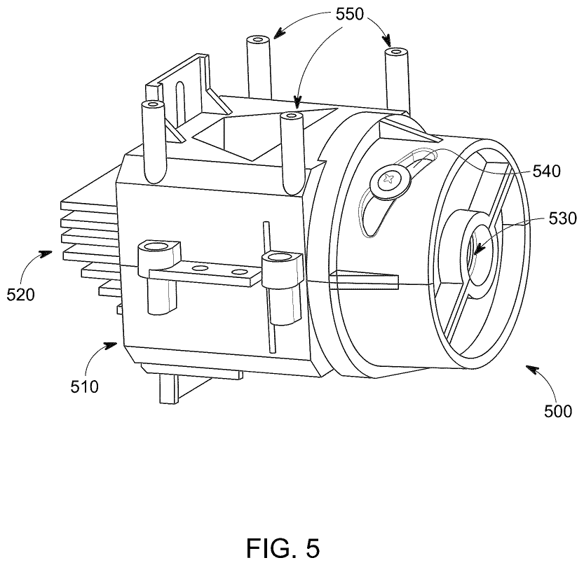

With reference to FIG. 5, an assembled projector 500 in accordance with some embodiments of the present invention will now be discussed. Projector 500 may comprise a housing 510, a heat sink 520 extending exterior to the housing 510, an aperture 530 for an image or video to be projected outside of the housing 510, optional adjustment configuration 540—which may be used to focus one or more lenses, and one or more mounts 550 for mounting the projector 500.

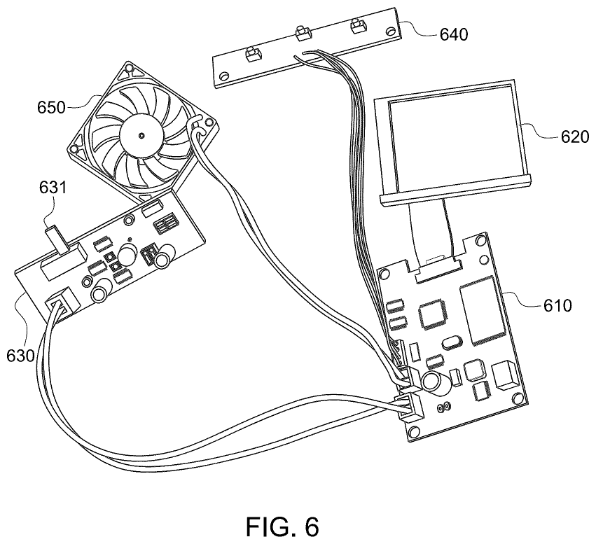

With reference to FIG. 6, exemplary electronic components will now be discussed. Electronic components may include a LCD driver 610, which may include flash memory for storing audio and/or video; an LCD 620 for displaying files to be projected; a power board 630, which may include a power button 631; a button board 640; and/or a fan 650. Note that there may be various other components—such as an input for a power source such as a battery pack and/or a direct input for alternating current or direct current, or mobile, WiFi, or Bluetooth chip to enable communication with a user device. In this manner, a user may communicating with the projector and may provide files to be played by the projector.

Note that while the present invention has been discussed in applications such as household items, decorations, and toys, it is contemplated that a projector in accordance with some embodiments of the present invention may have applications in promotional products, demonstration products, show products, medical applications, and/or military applications.

It will be understood that the specific embodiments of the present invention shown and described herein are exemplary only. Numerous variations, changes, substitutions and equivalents will now occur to those skilled in the art without departing from the spirit and scope of the invention. For example, lenses may be exchangeable or swapable, either individually or as part of an overall lens sleeve. Accordingly, it is intended that all subject matter described herein and shown in the accompanying drawings be regarded as illustrative only, and not in a limiting sense, and that the scope of the invention will be solely determined by the appended claims.

What is claimed is:

1. A projector for use in a household item, decoration, or toy, the projector comprising:
at least two housing shells, which mate together to form a projector housing, the at least two housing shells comprising a reflector cone portion molded into the at least two housing shells;
a printed circuit board, comprising a memory store, processor, and video driver.
a liquid crystal display (LCD) for displaying an image, animation, and/or video;
a light emitting diode (LED), configured to emit light though the LCD, thereby projecting the image, animation, and/or video on the LCD;
one or more Fresnel lenses, disposed between the LED and the exterior of the projector;
one or more lenses, disposed between the LCD and the exterior of the projector.

2. The projector of claim 1, further comprising a diffuser, disposed at least in part around the LED.

3. The projector of claim 1, further comprising a heat sink, thermodynamically connected to LED.

4. The projector of claim 3, wherein the heat sink comprises one or more fins, and wherein the fins extend in a substantially vertical direction.

5. The projector of claim 3, wherein the heat sink comprises one or more fins, and wherein the fins extend beyond the at least two housing shells.

6. The projector of claim 1, wherein the reflector cone molded into the at least two housing shells is polished to provide a reflective surface.

7. The projector of claim 1, wherein the at least two housing shells comprise one or more mounts molded into the at least two housing shells to provide support for the LCD and LED.

8. The projector of claim 7, further comprising one or more mounts molded into the at least two housing shells to provide support for the Fresnel lenses and other lenses.

9. A projector for use in a household item, decoration, or toy, the projector comprising:
at least two housing shells, which mate together to form a projector housing, the at least two housing shells comprising a reflector cone portion molded into the at least two housing shells, the reflector cone portion polished to provide a reflective surface, the at least two housing shells molded to provide one or more mounts for various components;
a printed circuit board, comprising a memory store, processor, and/or video driver;
a liquid crystal display (LCD) for displaying an image, animation, and/or video;
a light emitting diode (LED), configured to emit light though the LCD, thereby projecting the image, animation, and/or video on the LCD;
a diffuser, disposed at least in part around the LED;
one or more Fresnel lenses, disposed between the LED and the exterior of the projector;
one or more lenses, disposed between the LCD and the exterior of the projector; and
a heat sink, thermodynamically connected to the LED and configured to dissipate heat generated by the LED.

10. The projector of claim 9, wherein the heat sink comprises one or more fins extending in a substantially vertical direction.

11. The projector of claim 10, wherein the fins extend beyond the at least two housing shells.

12. The projector of claim 9, wherein the mounts for various components support at least one of the LCD, LED, one or more Fresnel lenses, and/or one or more other lenses.
